(19) United States
(12) Patent Application Publication
(10) Pub. No.: US 2023/0383867 A1
(43) Pub. Date: Nov. 30, 2023

(54) DROP HOSE CLAMP

(71) Applicant: NELSON IRRIGATION CORPORATION, Walla Walla, WA (US)

(72) Inventors: Tanner R. DRUFFEL, Walla Walla, WA (US); Andrew B. HELLIE, College Place, WA (US); Craig B. NELSON, Walla Walla, WA (US); Meade M. NEAL, Walla Walla, WA (US)

(21) Appl. No.: 18/200,007

(22) Filed: May 22, 2023

Related U.S. Application Data
(60) Provisional application No. 63/346,048, filed on May 26, 2022.

(51) Int. Cl. F16L 3/08; F16L 3/10

(52) U.S. Cl. CPC F16L 3/085; F16L 3/1075; A01G 25/02

(57) ABSTRACT

A drop hose clamp for securing a drop hose in a center pivot irrigation system includes a bottom section positionable over a truss rod or in engagement with a span pipe, and a top section pivotally connected to the bottom section and displaceable between an open position and a closed position. With the top section in the closed position, the bottom section and the top section together define a channel that is configured to receive and secure the drop hose. The drop hose clamp may be secured to the truss rod or the span pipe using a connector positioned through a connector slot.

### CROSS-REFERENCES TO RELATED APPLICATIONS

This application claims the benefit of U.S. Provisional Patent Application Ser. No. 63/346,048, filed May 26, 2022, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a drop hose clamp for a center pivot irrigation system and, more particularly, to a drop hose clamp that secures the drop hose against the truss rod or the span pipe.

The drop hose clamp is designed specifically for drop hose irrigation. With reference to FIG. 21, this style of irrigation involves a long span pipe 101, which transports irrigation water along the span. Supporting the pipe 101 are truss rods 103. There are many truss rods 103 in the span that create this support for the pipe 101 and the water it carries. The truss rods 103 are used to rest drop hoses 105, thus creating a greater distance between hoses 105 on opposite sides of the span pipe 101.

### SUMMARY

It is desirable to secure the drop hose against the truss rod and/or pipe span to reduce the risk of drop hoses tangling in the wind or around the truss rod itself. Securing the drop hose similarly prevents polyline span pipes from breaking at the span pipe outlets.

The drop hose clamp of the described embodiments secures the drop hose in place against the truss rod or the span pipe. In use, drop hoses can get caught on objects closer to the ground, which results in pulling forces on the drop hose toward the ground. Securing the hose helps to avoid breaking of the outlets and accessories on top the span pipe. The drop hose clamp also prevents kinking of the hoses; and when installed in engagement with the truss rod, keeps the hose from wearing against the galvanized truss rod.

In an exemplary embodiment, a drop hose clamp for securing a drop hose in a center pivot irrigation system includes a bottom section positionable over a truss rod or in engagement with a span pipe, and a top section pivotally connected to the bottom section and displaceable between an open position and a closed position. With the top section in the closed position, the bottom section and the top section together define a channel that is configured to receive and secure the drop hose.

The top section may be pivotally connected to the bottom section via a living hinge. One of the bottom section and the top section may include a lock slot, and the other of the bottom section and the top section may include a locking tab, where the locking tab engages the lock slot with the top section in the closed position. The drop hose clamp may also include a flare section positioned at least one of upstream and downstream ends of one or both of the bottom section and the top section. The top section may further include a slot bar disposed on an exterior surface that defines a connector slot. The top section may include at least one inner ridge on an interior surface thereof.

The bottom section may include a pair of support legs. In this context, the bottom section may include a truss rod channel between the pair of support legs. In some embodiments, the pair of support legs may be pitched to engage a curved outside diameter of the span pipe.

The bottom section may include alignment tabs on an interior surface thereof.

In another exemplary embodiment, a drop hose clamp for securing a drop hose in a center pivot irrigation system includes a bottom section positionable over a truss rod or in engagement with a span pipe, and a top section pivotally connected to the bottom section and displaceable between an open position and a closed position. The top section is lockable in the closed position. With the top section in the closed position, the bottom section and the top section together define a channel that is configured to receive and secure the drop hose. The bottom section includes a pair of support legs and a truss rod channel between the pair of support legs.

In yet another exemplary embodiment, a method of securing a drop hose in a center pivot irrigation system using a drop hose clamp includes the steps of (a) securing the drop hose clamp on the drop hose; (b) positioning the drop hose clamp on one of a truss rod or a span pipe; and (c) securing the drop hose clamp to the one of the truss rod or the span pipe.

Step (a) may include pivoting the top section relative to the bottom section to an open position, positioning the drop hose between the top section and the bottom section, and pivoting the top section relative to the bottom section to a closed position.

The bottom section may include a pair of support legs and a truss rod channel between the pair of support legs, where step (b) may include positioning the truss rod channel on the truss rod. The top section may include connector slot, and step (c) may include inserting a wire through the connector slot and wrapping the wire around the truss rod on opposite sides of the drop hose clamp.

Step (b) may include positioning the pair of support legs on the span pipe, and step (c) may include securing a first worm gear hose clamp between the drop hose and the bottom section and around the span pipe, and securing a second worm gear hose clamp through the connector slot and around the bottom and top sections of the drop hose clamp.

Steps (b) and (c) may be practiced before step (a).

### BRIEF DESCRIPTION OF THE DRAWINGS

These and other aspects and advantages will be described in detail with reference to the accompanying drawings, in which:

FIGS. 1-5 are various views of the drop hose clamp in a closed position;

FIG. 6 is a rear view of the drop hose clamp;

FIGS. 7 and 8 are rear perspective views of the drop hose clamp;

FIG. 9 shows the channel through the drop hose clamp defined by the bottom and top sections;

FIGS. 10 and 11 are views of the drop hose clamp in an open position;

FIGS. 12-17 show the drop hose clamp securing a drop hose against a truss rod;

FIGS. 18-20 show the drop hose clamp securing the drop hose against a span pipe; and

FIG. 21 shows an exemplary center pivot irrigation system.

### DETAILED DESCRIPTION

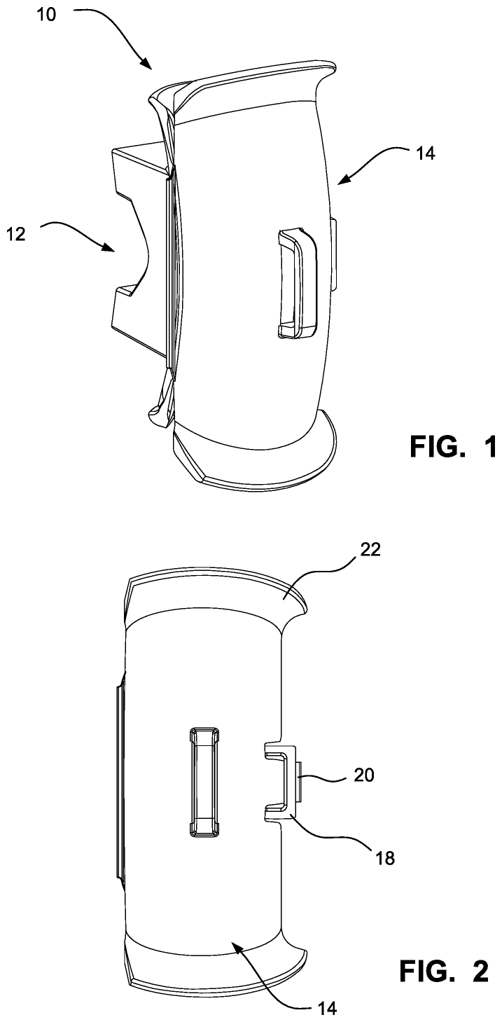

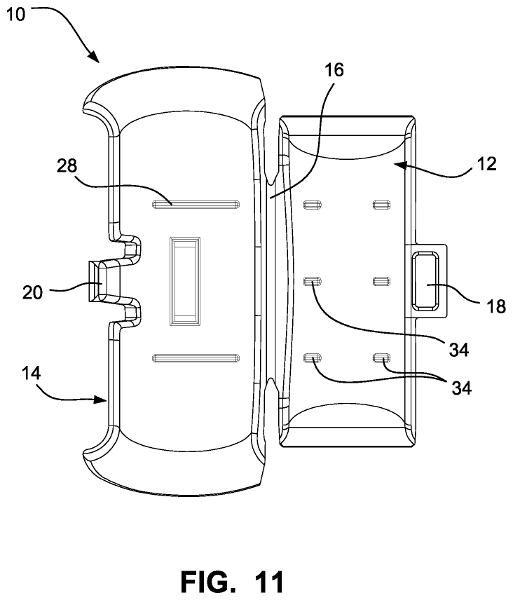

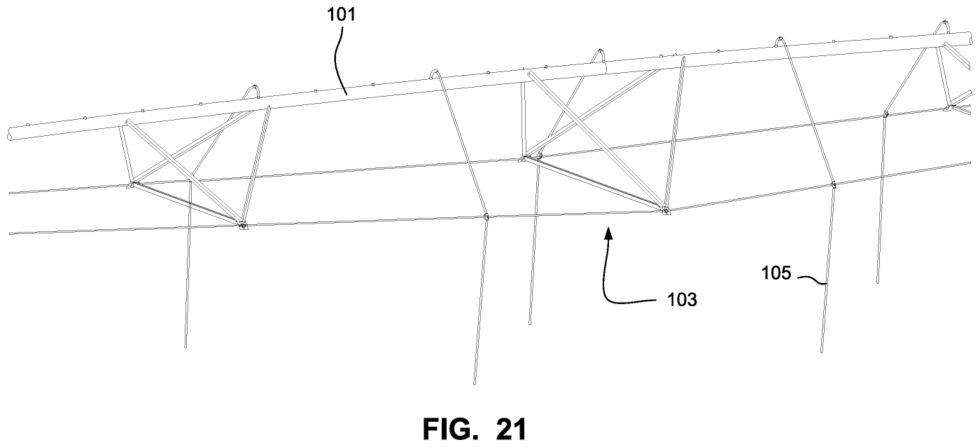

With reference to FIGS. 1-11, the drop hose clamp 10 according to the described embodiments is configured for securing a drop hose (e.g., drop hose 105 in FIG. 21) in a center pivot irrigation system. The drop hose clamp 10 includes a bottom section 12 positionable over a truss rod (e.g., truss rod 103 in FIG. 21) or in engagement with a span pipe (e.g., span pipe 101 in FIG. 21). A top section 14 is pivotally connected to the bottom section 12 and is displaceable between an open position shown in FIGS. 10 and 11 and a closed position as shown in FIGS. 1-9. In some embodiments, the top section 14 is pivotally connected to the bottom section 12 via a living hinge 16 (FIGS. 10 and 11).

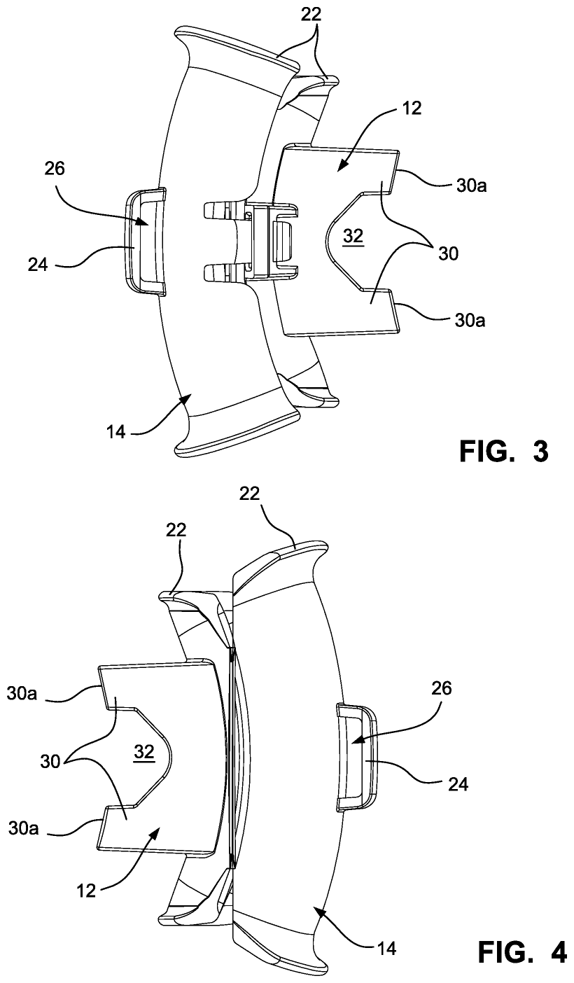

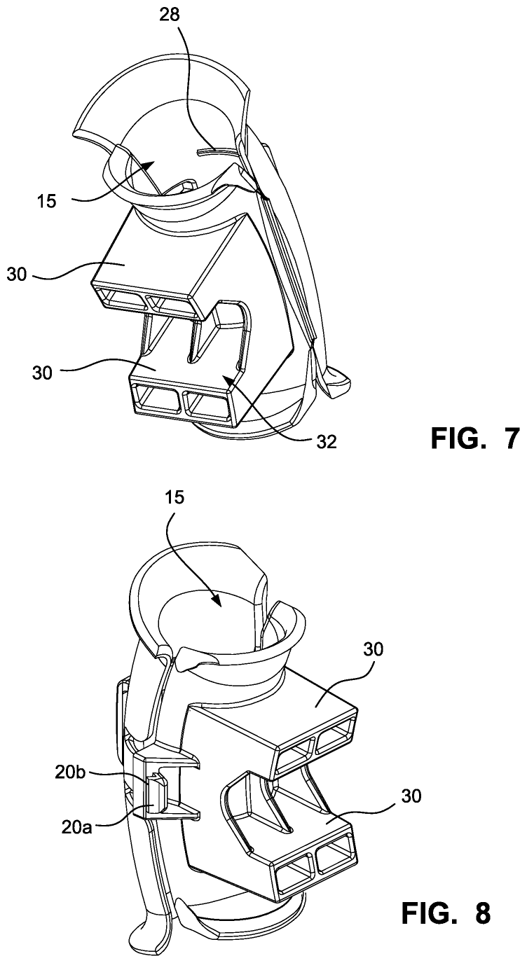

The bottom section 12 and the top section 14 together define a channel 15 that is configured to receive and secure the drop hose. (See, e.g., FIG. 7.) The channel can accommodate a variety of drop hose outside diameters. As shown best in FIGS. 3 and 4, in the closed position, the drop hose clamp 10 has a curved profile.

The drop hose clamp 10 may be molded from plastic as a single piece.

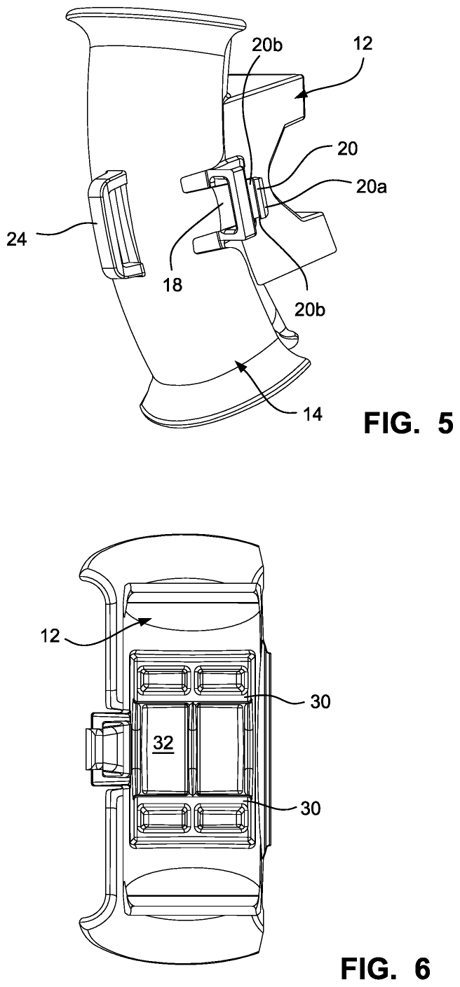

With particular reference to FIG. 5, the bottom section 12 is provided with a lock slot 18, and the top section 14 is provided with a locking tab 20. The locking tab includes an inclined surface 20a and a shoulder 20b such that the locking tab 20 is insertable through the lock slot 18 and displaces the locking tab 20 and/or lock slot 18 via the ramp surface 20a until the shoulder 20b passes through the slot 18. The locking tab thus engages the lock slot 18 in a snap fit. As would be appreciated by those of ordinary skill in the art, the lock slot 18 and the locking tab 20 may be reversed such that the lock slot 18 is formed on the top section 14, and the locking tab 20 is formed on the bottom section 12.

The drop hose clamp may be provided with one or more flare sections 22 at upstream and downstream ends of one or both of the bottom section 12 and the top section 14. The flare sections 22 help prevent hose kink and hose wear.

A slot bar 24 may be connected across the top section 14. In the exemplary embodiment shown, the slot bar is oriented longitudinally along the top section 14. The slot bar 24 could be oriented laterally or at an angle. The slot bar 24 defines a connector slot 26.

With reference to FIG. 11, the top section 14 may also be provided with at least one inner ridge 28 on an interior surface thereof. In FIG. 11, the top section 14 includes two inner ridges 28. The inner ridges 28 provide for a more secure engagement with the drop hose.

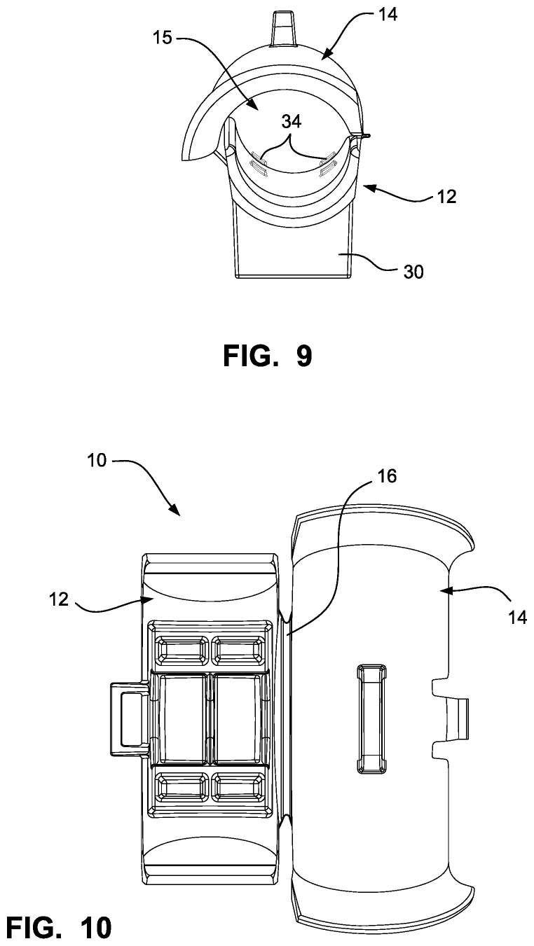

With particular reference to FIGS. 6-8 and 10, the bottom section 12 may be provided with a pair of support legs 30 and a truss rod channel 32 defined between the pair of support legs 30. As shown in FIGS. 3-5, the support legs 30 or at least the bottoms 30a thereof are pitched to engage the curved outside diameter of a span pipe (e.g., span pipe 101 as shown in FIG. 21). The bottom section 12 may also be provided with alignment tabs 34 on an interior surface thereof. (See, e.g., FIGS. 9 and 11.)

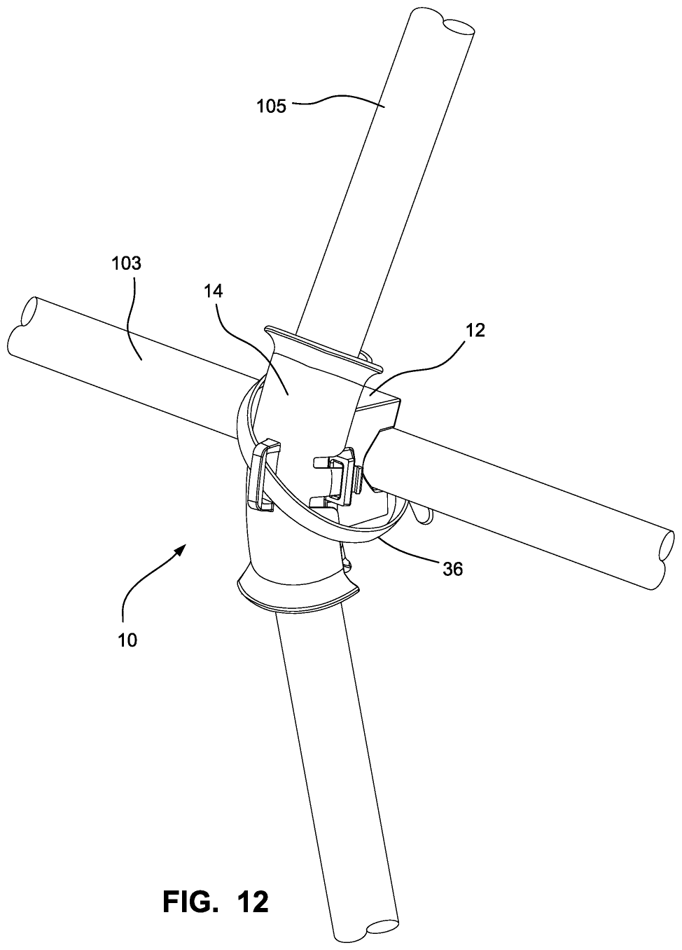

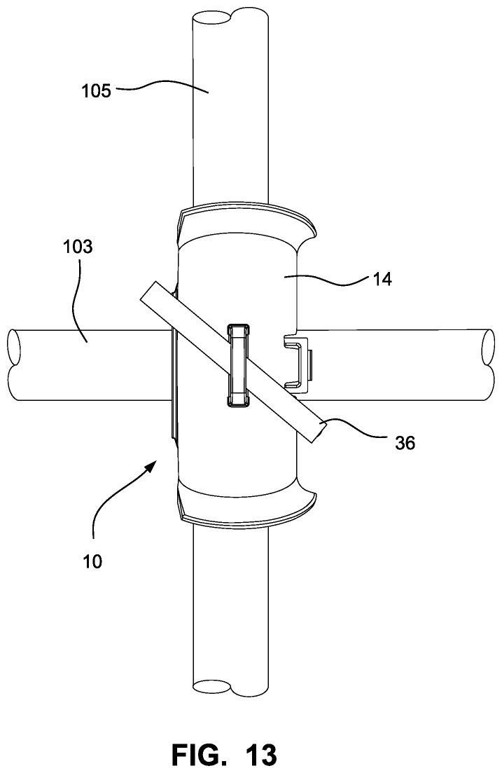

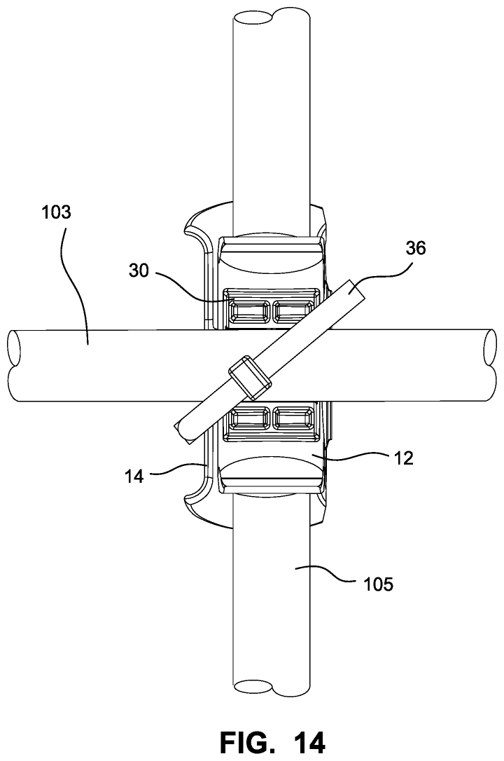

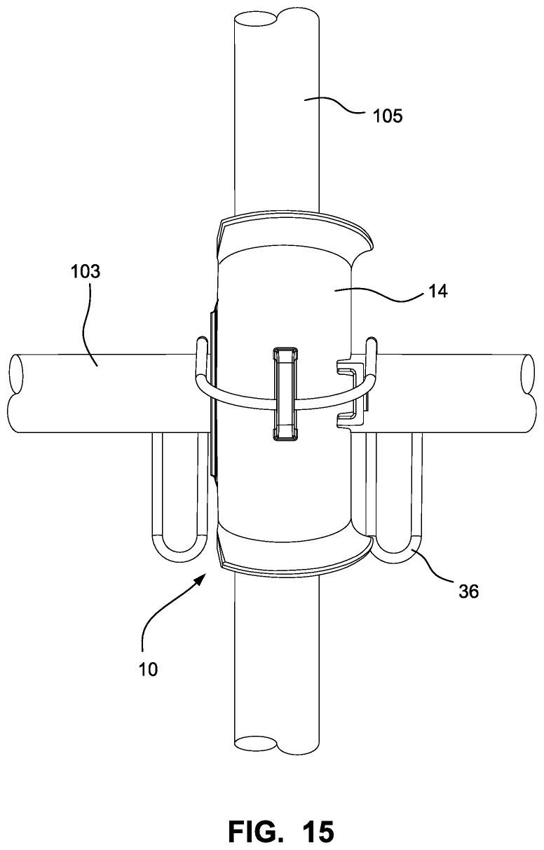

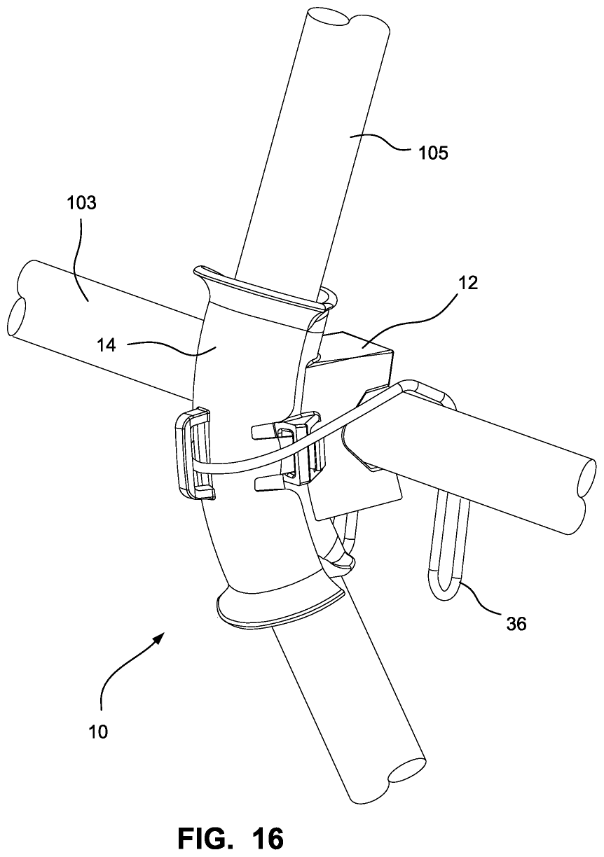

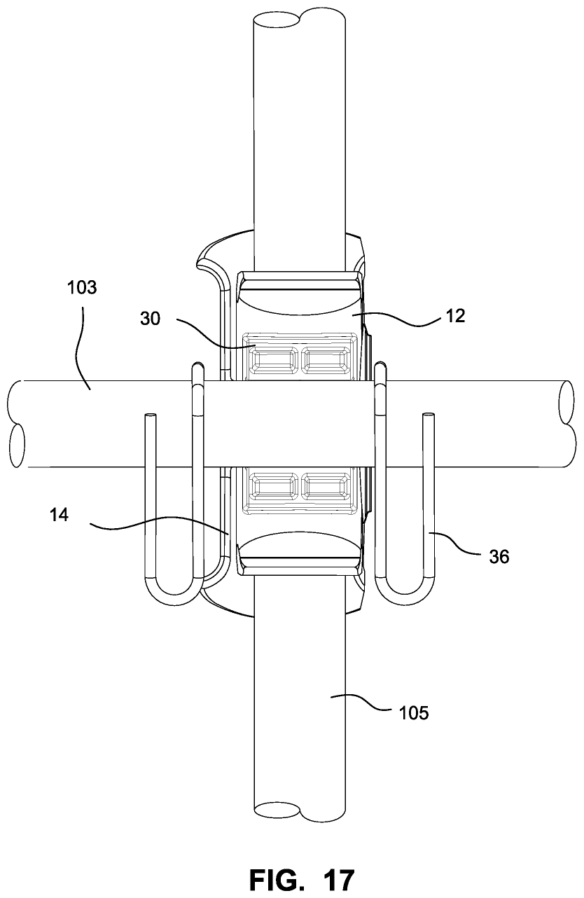

FIGS. 12-17 show an exemplary application of the drop hose clamp 10 for securing the drop hose 105 against a truss rod 103. With the top section 14 pivoted to an open position relative to the bottom section 12 via the living hinge 16, the drop hose clamp 10 can be installed over the drop hose 105 with the drop hose positioned in the channel 15 defined by the bottom section 12 and the top section 14. The top section 14 is subsequently pivoted to a closed position by securing the top section 14 to the bottom section by inserting the locking tab 20 through the lock slot 18.

In the exemplary application shown in FIGS. 12-17, the drop hose clamp 10 is positioned on the drop hose 105 so that the truss rod channel 32 is positioned over the truss rod 103. Subsequently, a connector 36 is inserted through the connector slot 26 and is secured to the truss rod 103. In some embodiments, the connector 36 is a wire of aluminum or steel or other suitable material that is inserted through the connector slot 26 and wrapped or coiled around the truss rod 103. The connector may be secured by hand or with the assistance of a tool depending on the material of the connector.

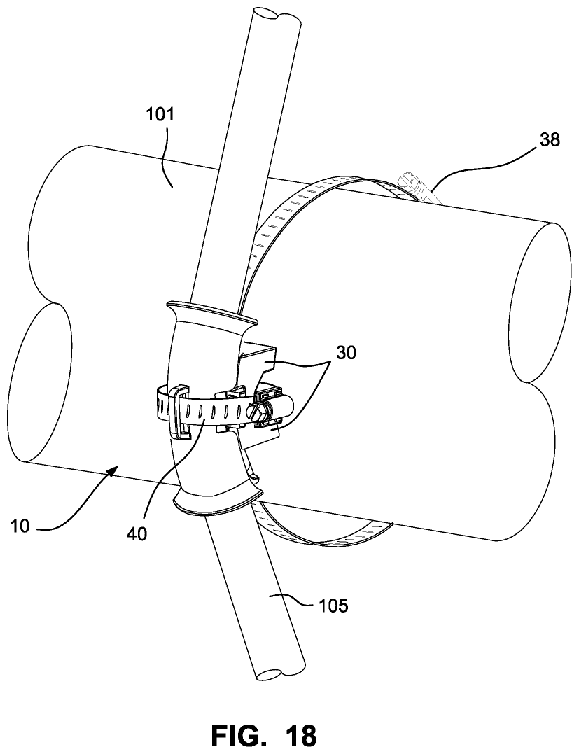

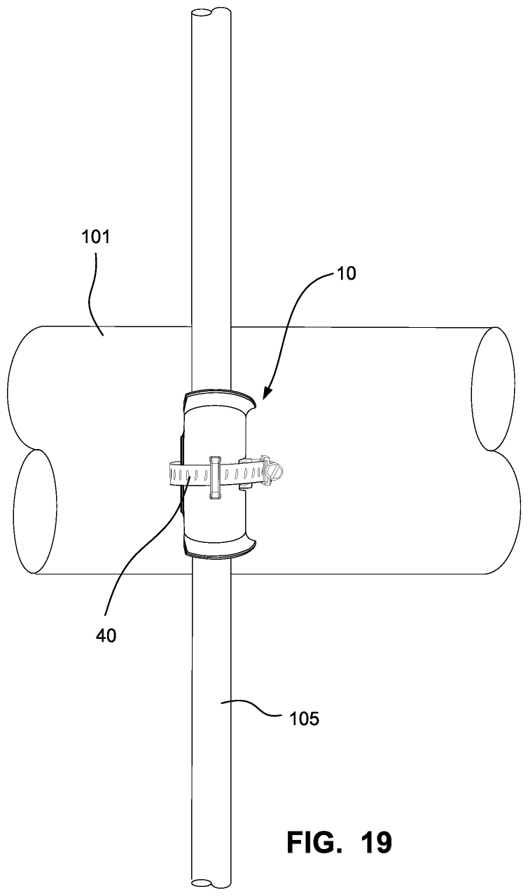

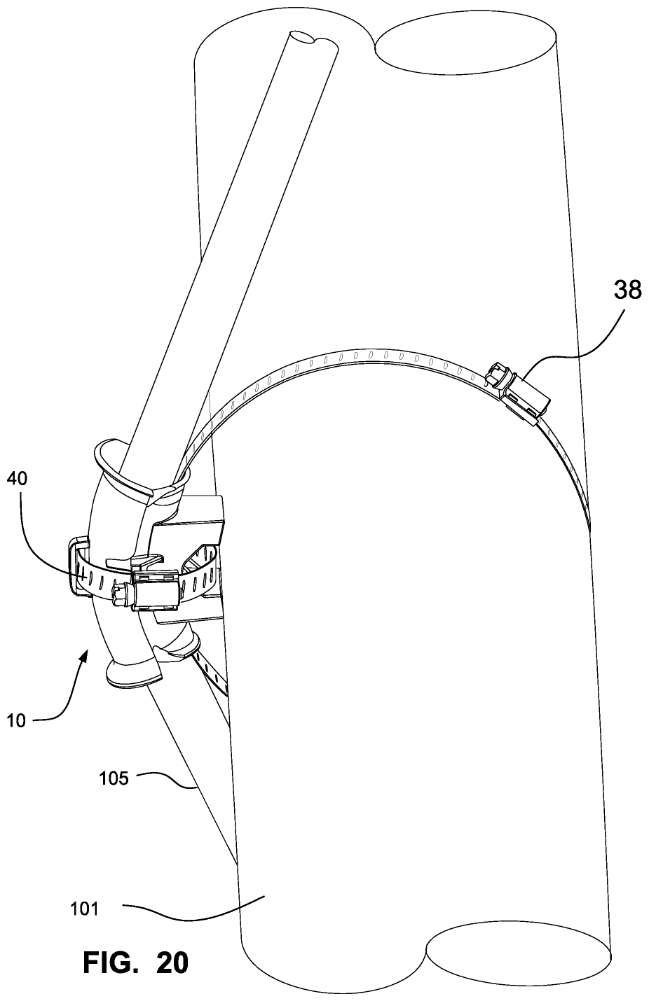

FIGS. 18-20 show an exemplary application with the drop hose clamp 10 secured on the span pipe 101. In this application, the support legs 30 are positioned on the span pipe 101, and the drop hose clamp 10 is secured in place via a first worm gear hose clamp 38. As noted above, the support legs 30 are pitched in complement with the outside diameter of the span pipe 101 so that the drop hose clamp 10 sits flush against the span pipe 101. The drop hose 105 is then secured in the drop hose clamp 10. The first worm gear hose clamp 38 is thus positioned between the drop hose 105 and the interior surface of the bottom section 12 between the alignment tabs 34 (FIG. 11) on the interior surface of the bottom section 12. The alignment tabs 34 secure a position of the first worm gear hose clamp 38 inside the drop hose clamp 10.

A second worm gear hose clamp 40 may be secured through the connector slot 26 and around the bottom and top sections 12, 14 of the drop hose clamp 10. The second worm gear hose clamp 40 may be positioned between the support legs 30 in the truss rod channel 32. In some embodiments, the second worm gear hose clamp 40 may be secured on the drop hose clamp 10 prior to securing the drop hose clamp 10 to the span pipe 101.

The drop hose clamp of the described embodiments secures the drop hose in place against the truss rod or the span pipe. The clamp can accommodate various drop hose outside diameters. Securing the drop hose in a center pivot irrigation system prevents wear on the drop hose and prevents polyline span pipes from breaking at the hose outlet.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A drop hose clamp for securing a drop hose in a center pivot irrigation system, the drop hose clamp comprising:
a bottom section positionable over a truss rod or in engagement with a span pipe; and
a top section pivotally connected to the bottom section and displaceable between an open position and a closed position,
wherein with the top section in the closed position, the bottom section and the top section together define a channel that is configured to receive and secure the drop hose.

2. A drop hose clamp according to claim 1, wherein the top section is pivotally connected to the bottom section via a living hinge.

3. A drop hose clamp according to claim 1, wherein one of the bottom section and the top section comprises a lock slot, and wherein the other of the bottom section and the top section comprises a locking tab, the locking tab engaging the lock slot with the top section in the closed position.

4. A drop hose clamp according to claim 1, further comprising a flare section positioned at least one of upstream and downstream ends of one or both of the bottom section and the top section.

5. A drop hose clamp according to claim 4, comprising the flare section at both the upstream and downstream ends of both of the bottom section and the top section.

6. A drop hose clamp according to claim 1, wherein the top section further comprises a slot bar disposed on an exterior surface and defining a connector slot.

7. A drop hose clamp according to claim 1, wherein the top section comprises at least one inner ridge on an interior surface thereof.

8. A drop hose clamp according to claim 1, wherein the bottom section comprises a pair of support legs.

9. A drop hose clamp according to claim 8, wherein the bottom section comprises a truss rod channel between the pair of support legs.

10. A drop hose clamp according to claim 8, wherein the pair of support legs are pitched to engage a curved outside diameter of the span pipe.

11. A drop hose clamp according to claim 1, wherein the bottom section comprises alignment tabs on an interior surface thereof.

12. A drop hose clamp for securing a drop hose in a center pivot irrigation system, the drop hose clamp comprising:
a bottom section positionable over a truss rod or in engagement with a span pipe; and
a top section pivotally connected to the bottom section and displaceable between an open position and a closed position, wherein the top section is lockable in the closed position,
wherein with the top section in the closed position, the bottom section and the top section together define a channel that is configured to receive and secure the drop hose, and
wherein the bottom section comprises a pair of support legs and a truss rod channel between the pair of support legs.

13. A drop hose clamp according to claim 12, wherein the pair of support legs are pitched to engage a curved outside diameter of the span pipe.

14. A method of securing a drop hose in a center pivot irrigation system using a drop hose clamp including a bottom section and a top section pivotally connected to the bottom section, the method comprising:
(a) securing the drop hose clamp on the drop hose;
(b) positioning the drop hose clamp on one of a truss rod or a span pipe; and
(c) securing the drop hose clamp to the one of the truss rod or the span pipe.

15. A method according to claim 14, wherein step (a) comprises pivoting the top section relative to the bottom section to an open position, positioning the drop hose between the top section and the bottom section, and pivoting the top section relative to the bottom section to a closed position.

16. A method according to claim 14, wherein the bottom section comprises a pair of support legs and a truss rod channel between the pair of support legs, and wherein step (b) comprises positioning the truss rod channel on the truss rod.

17. A method according to claim 16, wherein the top section comprises a connector slot, and wherein step (c) comprises inserting a wire through the connector slot, and wrapping the wire around the truss rod on opposite sides of the drop hose clamp.

18. A method according to claim 14, wherein the bottom section comprises a pair of support legs and the top section comprises a connector slot, wherein step (b) comprises positioning the pair of support legs on the span pipe, and wherein step (c) comprises securing a first worm gear hose clamp between the drop hose and the bottom section and around the span pipe, and securing a second worm gear hose clamp through the connector slot and around the bottom and top sections of the drop hose clamp.

19. A method according to claim 14, wherein steps (b) and (c) are practiced before step (a).
